(19) United States
(12) Patent Application Publication
(10) Pub. No.: US 2006/0063912 A1
(43) Pub. Date: Mar. 23, 2006

(54) Method and apparatus for insoluble reduction in tallow

(76) Inventors: Dennis K. Mullane, Wichita, KS (US); Mike L. Wiens, Wichita, KS (US); Daryl L. Kuker, Dodge City, KS (US); Valerie J. Mullane, Wichita, KS (US)

Correspondence Address: CHIEF INTELLECTUAL PROPERTY COUNSEL;CARGILL, INCORPORATED, 15407 MCGINTY ROAD WEST, WAYZATA, MN, 55391-2399, US

(21) Appl. No.: 11/198,922

(22) Filed: Aug. 5, 2005

Related U.S. Application Data
(60) Provisional application No. 60/599,207, filed on Aug. 5, 2004.

(51) Int. Cl. C09F 7/00

(52) U.S. Cl. 530/230

(57) ABSTRACT

A method and apparatus for insoluble reduction in tallow using water and a polisher. The system for insoluble reduction in tallow includes a tallow tank, a mixer, and a separator. The tallow is pumped into and held in the tallow tank. The tallow is mixed with water to form a tallow and water mixture. The tallow and water mixture is run through a separator where insolubles and cleaned tallow are separated.

### FIELD OF THE INVENTION

This invention relates generally to a method and apparatus for insoluble reduction in tallow, and more specifically to a method and apparatus for insoluble reduction in tallow using water and a polisher.

### BACKGROUND

At various stages during meat production, trimmings of fat are recovered and are rendered down to edible and inedible tallows. Edible tallows are commonly used as frying fats, as shortening for use in baking, as oleic oil for use in baker products, and as confectionary and industrial margarine. Inedible tallows are commonly used to make soap, lubricants, animal feed, leather dressings, candles, and tallow for tanning.

The OIE international animal health code provides that only protein-free tallow (maximum level of insoluble impurities of 0.15% in weight) and derivatives made from this tallow may be included in ruminant feeds. While the United States and Canada do not currently have a similar requirement, meeting this level is still considered of value. Further, insolubles reduction in tallow eliminates or reduces the cost of tank cleaning and railcar cleaning, provides increased consistency to the finished product, and opens additional market opportunity.

### BRIEF SUMMARY

A method and apparatus for insoluble reduction in tallow using water and a polisher is provided. The system for insoluble reduction in tallow includes a tallow tank, a mixer and a separator. The tallow is pumped into and held in the tallow tank. The tallow is mixed with water using the mixer. The tallow and water are pumped to a separator. The separator separates insolubles from the cleaned tallow.

While multiple embodiments are disclosed, still other embodiments of the invention will become apparent to those skilled in the art from the following detailed description, which shows and describes illustrative embodiments of the invention. As will be realized, the invention is capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

FIG. 1 illustrates a block diagram flow chart for reducing insolubles in tallow in accordance with one embodiment of the present invention.

FIG. 2 illustrates a component flow chart for reducing insolubles in tallow in accordance with one embodiment of the present invention.

FIG. 3 illustrates a suitable tallow dryer for use in drying the reduced tallow during a process for reducing insolubles in tallow in accordance with one embodiment of the present invention.

FIG. 4 illustrates a block diagram of a component flow chart for reducing insolubles in tallow in accordance with one embodiment of the present invention.

FIG. 5 illustrates process flow for reducing insolubles in tallow in accordance with one embodiment of the present invention.

### DETAILED DESCRIPTION

A method and apparatus for insoluble reduction in tallow is provided. More specifically, a method and apparatus for insoluble reduction in tallow using water and a polisher is provided.

Reduction of insolubles in tallow provides several benefits both during production and to the end product. During meat production, reduction of solids facilitates tank cleaning. With regards to the final product, reduction of solids in tallow positively impacts its functional use as beef meat and bone meal (MBM) free for cattle feeding and other applications that may be sensitive to MBM. Reduction of solids also reduces free fatty acid (FFA) growth.

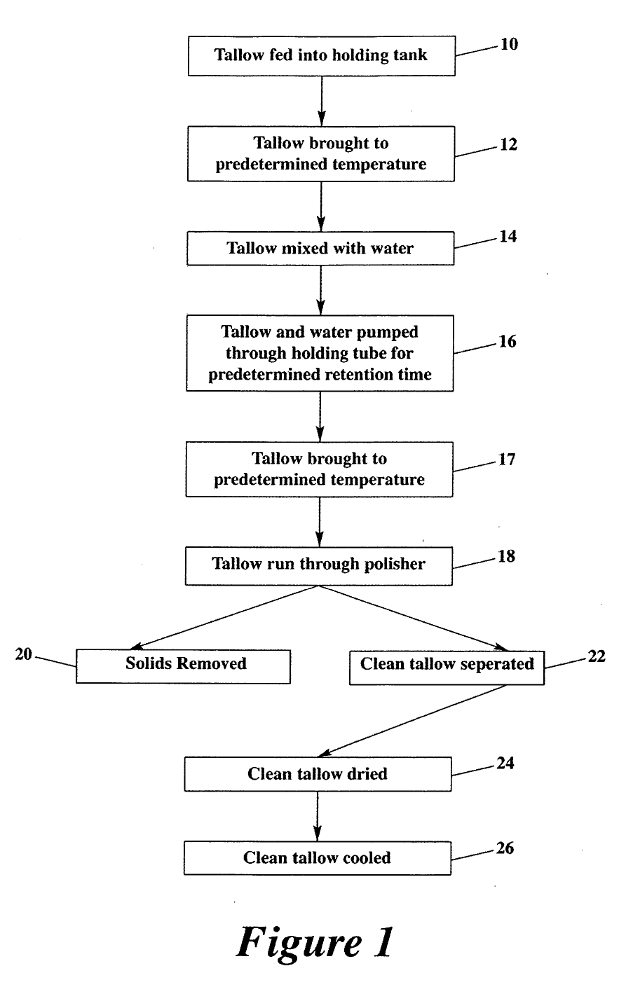

FIG. 1 illustrates a block diagram chart of insoluble reduction in tallow in accordance with one embodiment of the present invention. Tallow is fed into a tallow tank, shown at block 10. The tallow may come from any source, example sources being beef, fat, bone and viscera. The tallow is mixed with water (whether in liquid or gas form) at a mixing pump. The mixture is then processed to a holding tube assembly, shown at block 14. The mixture is processed by a polisher (or separator), shown at block 18. In one embodiment, the polisher is a 2-phase centrifuge. Alternatively, other suitable polishers may be used. The polisher separates solids (insolubles such as protein) from the clean tallow, shown at blocks 20 and 22.

Prior to mixing with water, the tallow may be heated or cooled to a predetermined temperature, for example approximately 205° F., using a first heat exchanger shown at block 12. After mixing, the tallow and water mixture may be held for a predetermined retention time or dwell time, shown at block 16. Holding may be effected using a holding tube assembly. One suitable retention time is approximately five minutes. After the holding and prior to processing by the polisher, the mixture of tallow and water may pass through a second heat exchanger to maintain a predetermined temperature, for example approximately 205° F., shown at block 17. After polishing, the solids may be removed and fed back to a cooker of a rendering process—thus, the solids may be recovered and put back into MBM, for example. The clean tallow may be dried using a tallow dryer to remove excess water, shown at block 24. After the clean tallow is dried, it may be cooled using a third heat exchanger, shown at block 26.

A specific embodiment of tallow processing is as follows. At blocks 10 and 12, the tallow (or product) enters a supply tank and is pumped to a product-heating or cooling skid, for example using an off skid supply/CIP pump. The tallow is heated or cooled to a predetermined temperature, for example approximately 205° F., using a plate and frame heat exchanger, where temperature may be monitored, for example using an RTD, and flow rate may be monitored using a flow meter. At block 14, the tallow passes through a mixer and onto a holding tube skid. The tallow and water are mixed at the mixer and flow through the holding tube assembly for a predetermined retention time, shown at block 16. The mixture passes through a jacketed holding tube and associated valves on the way to a plate and frame heat exchanger, for heating or cooling to a predetermined temperature, for example approximately 205° F. The mixture is then processed to a separator. The separator separates solids (insolubles such as protein) from the tallow, shown at block 18-22. After the separator, the tallow falls into an off skid balance tank and is pumped to a tallow dryer skid. The tallow is dried, at block 24, checked for excessive water content and cooled, at block 26, before being sent to storage.

The mixing and retention time (dwell time) to combine the tallow and water is set for maximizing the suitability of the mixture for processing by the polisher. The retention time is determined such that the water and tallow are able to bond with the solids. Generally, a suitable retention time is at least approximately five minutes. Such a retention time enables the water and solids to bond such that when going through the separator, the solids are heavier and more easily separated out. In a tallow reduction apparatus, the piping and sizing may be configured to provide such a retention time. Thus, the retention time may be integrally provided while the tallow or mixture travels from one process to the next. Alternatively, holding areas may be provided for holding the tallow or mixture for the retention time before feeding the tallow or mixture to a further process.

Using the method for insoluble reduction in tallow, the color and insolubles of the product are altered. Further, with reduced moisture and insolubles, the free fatty acid (FFA) content of the product is generally stabilized and will not grow.

A method and apparatus for insoluble reduction in tallow was run in the example of which the results are shown in Table 1 below. The table gives only example results and is not intended to be limiting. Further, while the table reflects an “after” insolubles level of 0.02, the method and apparatus are generally suitable for achieving an “after” insolubles level of approximately 0.15 or less.

TABLE 1

| | Before | After |
|---|---|---|
| Color (FAC) | 17 | 11 to 9 |
| Insoluble | 0.36 | 0.02 or less |
| Acid | 0.9 | 0.8 |

Overall Tallow Polishing System

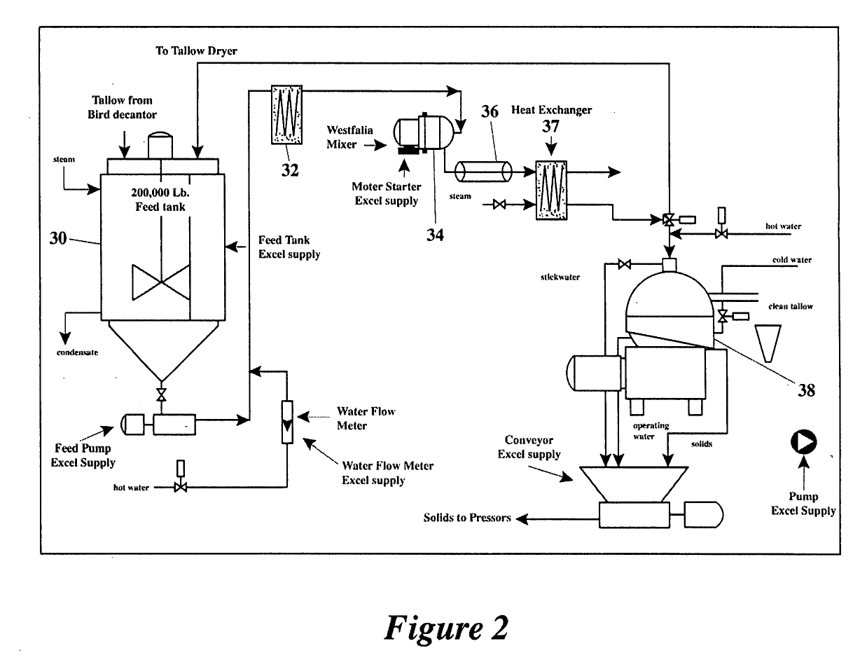

FIG. 2 illustrates one embodiment of a process flowchart of insoluble reduction in tallow.

As shown in FIG. 2, the tallow enters a tallow tank (or feedtank) 30. The tallow passes through a first heat exchanger 32 where the tallow is heated or cooled to a predetermined temperature. The tallow is mixed with water using a mixer 34. The tallow and water mixture is pumped through a holding tube assembly 36 to achieve a predetermined retention time before being fed through a second heat exchanger and then through a separator 38. The separator 38 separates solids from the clean tallow.

Thus, a system for insoluble reduction in tallow according to the embodiment of FIG. 2 includes a tallow tank, a first heat exchanger, a mixer, a holding tube assembly, a second heat exchanger, a separator, and a tallow dryer. Alternative embodiments of the system for insoluble reduction in tallow may include more or fewer components. For example, one or both of the heat exchangers as well as the tallow dryer may be omitted. A holding tank may be used in lie of a holding tube assembly. The tallow may be processed directly to the mixer and the tallow tank may be omitted. Other variations may be used as would be obvious to one skilled in the art.

A tallow tank for use in the polishing system may be provided in any suitable configuration for holding any suitable capacity. One example of a tallow tank is a 200,000 gallon tank.

First and second heat exchangers may be used for heating or cooling the tallow to a predetermined temperature. In one embodiment, the first heat exchanger brings the tallow to approximately 205° F. and the second heat exchanger brings the tallow and water mixture to approximately 205° F. The first and second heat exchangers may be configured as plate and frame heat exchangers and may be skid-mounted. A feed pump, a control panel, a modulating valve, and a mass flow meter may be associated with each heat exchanger. In some embodiments, one or both of the first and second heat exchangers may be omitted.

A mixer is provided for mixing the tallow with water (in liquid or gas form). A suitable mixer is a Westfalia ZA 40-66-905 Mixer, 3 KW/4 HP 480 volt 60 Hz 3 phase, available from Westfalia Separator, Inc. Alternatively a static mixer or other suitable mixer may be used.

A holding tube assembly 36 is provided through which the water and tallow mixture flow for a retention time. The size of the holding tube assembly 36 may be configured to provide a predetermined dwell time while the mixture flows through the holding tube assembly. In one embodiment, the size of the holding tube assembly 36 is configured to provide a dwell time of approximately five minutes. The holding tube assembly 36 may comprise two or more separate sections of jacketed hold tube connected to one another. Alternatively, the holding tube assembly 36 may comprise a single section of jacketed hold tube. In lieu of a holding tube assembly, piping may be provided for transporting the mixture from the mixer to a holding tank and from the holding tank to the separator with the holding tank holding the mixture for a dwell time.

A separator (or polisher) 38 processes the mixture and separates the solids from the tallow. The separator may include process valves, an electronic timing unit, and a motor starter. A suitable separator is a Westfalia Separator SA 100-06-177 available from Westfalia Separator, Inc. Alternatively, other suitable separators may be used. In one embodiment, the process valves include a feed, flush, discharge and air/water control unit. The timing unit may be used to monitor and sequence separator operation. A suitable electronic timing unit is an Allen Bradly PLC mounted in a NEMA 4× stainless steel enclosure. Alternatively, other suitable timing units may be used. A suitable motor starter is a Special Toshiba VFD Motor Starter mounted in a NEMA 12 carbon steel painted enclosure, 460 volt, 60 cycle, 3 phase. Alternatively, other suitable starters may be used.

In a specific embodiment, the polisher 38 is a two-phase vertical centrifuge. The polisher 38 may be configured with a mixing pump and jacketed piping to ensure contact time for a continuous flow. Other configurations of polisher may alternatively be used.

A balance tank, a pump, and a control assembly may be provided. The balance tank receives the tallow and water mixture from the separator prior to processing to the dryer. The balance tank may be skid mounted. A monitoring system may be provided to monitor the level of tallow in the balance tank and the tallow dryer, described below, and adjust flow rate of the tallow to maintain appropriate levels. The level of the balance tank may be maintained by controlling pump speed. The pump speed may be controlled, for example, using a variable frequency drive (VFD) and a high temperature pressure transmitter. The monitoring system may be skid-mounted.

A tallow dryer is provided for drying the separated tallow. The tallow dryer may be skid mounted. Flow rate to the dryer may be automatically adjusted to maintain appropriate levels in the balance tank and the dryer. The tallow dryer may be configured to lower the moisture level of the tallow after the polisher. The dryer further may be configured to automatically remove excess water from liquid tallow using a vacuum tank. Once the tallow is dried, it may be cooled using a plate and frame heat exchanger.

Tallow Polishing System

A tallow polishing system in accordance with one embodiment comprises three skid-mounted components, two off skid pumps, and one off skid balance tank. The first skid mounted system is a jacketed holding tube, the second skid mounted system is a tallow cooling skid, and the third skid mounted system is the tallow dryer. The jacketed holding tube is a component of a tallow holding system, discussed more fully below. The tallow dryer is also discussed more fully below.

Specifications for one embodiment of a tallow polishing system are provided. The specifications are exemplary only and are not intended to be limiting.

Field Piping Connections:
From product supply tank to supply/CIP pump
From supply/CIP pump to cooling skid heat exchanger
From cooling skid flow meter to mixer
From mixer to holding tube skid
From holding tube skid to separator
From holding tube skid to product supply tank
From separator to balance tank
From supply pump to vacuum tank
From dryer skid to product supply tank
From dryer skid to storage
Water to condenser
Water to dryer skid
Water from dryer skid
CIP to dryer skid
Water to cooling skid
Water from cooling skid to holding tube skid

Field Electrical Connections:
480V power to main enclosure
480V power to off skid supply pumps
480V power to metering pump
Power to flow meter
Air to main air enclosure
Air to cooling skid valves and holding tube skid valves
Control wiring from cooling skid RTD, flow meter, and level control

System Includes the Following:

Item 1: Off Skid Balance Tank & Supply Pump
100 gallon balance tank w/level control
3 hp centrifugal pump w/VFD
Adjustable pump legs
Pump isolation valves (butterfly type)

Item 2: Off Skid Supply/CIP PUMP
15 hp centrifugal pump w/CFD
Adjustable pump legs
Pump isolation valves (butterfly type)

Item 3: Tallow Dryer Skid:
CIP/Product divert valve
Vacuum tank w/sight glass and differential pressure level control
Vapor condensing unit
7.5 hp vacuum pump w/check valve
1 Ohp centrifugal pump w/VFD & check valve
Pump isolation valves (butterfly type)
Pro-Scan
Product divert valve w/air blow
Plate and frame tallow cooling heat exchanger w/RTD & isolation valves
Cooling water flow control valve
CIP/cooling water divert valve
Product/CIP divert valve
2.0″ box tubing skid frame
Adjustable vibration isolation feet
Stainless steel tubing
Allen Bradley SLC 5/05 PLC controller w/10 slot chassis
Panel View 600 OID
I/P transducer
E-stop push buttons
Main power disconnect
Power supply
Panel wiring and terminal connections
NEMA 4× main air enclosure
Air regulator and filter
Manual air isolation valves
Electric solenoid valves
Panel wiring and terminals

Item 4: Product Cooling Skid
Plate and frame tallow cooling heat exchanger w/RTD & isolation valves
Water metering pump w/VFD & check valve
Flow meter
Cooling water flow control valve
I/P transducer
2.0″ box tubing skid frame
Adjustable vibration isolation feet
Stainless steel tubing

Item 5: Holding Tube Skid
2.0″ box tubing skid frame
3.0″ stainless tubing for product
3.5″ tubing for hot waterjacket
Adjustable vibration isolation feet
Product/CIP divert valve
Product/CIP cross-body valve
   Tallow Holding System

In accordance with one embodiment, the tallow holding system comprises three components: a heat exchanger and pump assembly, a holding tube assembly, and a balance tank.

The heat exchanger brings the tallow to a predetermined temperature. A feed pump processes the mixture from the heat exchanger to the holding tube assembly. A control panel, a modulating valve, and a vortex flow meter may further be provided.

The holding tube assembly provides passage from heat exchanger to the separator and also provides a dwell time for the tallow and water mixture. The duration of the dwell time may be set by adjusting the size and length of the holding tube assembly. The holding tube assembly may include two or more separate sections of jacketed hold tube. In one embodiment, the sections of jacketed hold tube are sized to provide an approximately five-minute dwell time and is approximately 1200 feet long. The 1200 feet may be provided using two sections of hold tube, each section being approximately 600 feet. Alternately, a single section of hold tube, for example a single 1200 feet section, may be used.

The balance tank receives the tallow and water mixture from the separator assembly prior to processing to the tallow dryer. The balance tank may be skid mounted. A pump and control panel assembly may be provided with the balance tank. The balance tank level may be maintained by controlling pump speed using a variable frequency drive, and a high temperature transmitter.

A monitoring system monitors the level of tallow in the balance tank and the tallow dryer and automatically adjusts the flow rate to maintain appropriate levels. The monitoring system may be skid-mounted.

Specifications for one embodiment of a tallow holding system for a system for insoluble reduction in tallow are provided. The specifications are exemplary only and are not intended to be limiting.

Item 1: Product Feed System
Plate and Frame Tallow Cooling Heat Exchanger
Waukesha 220 Positive Displacement Feed Pump
Gear Reducer
15 hp Wash-down Motor
2.0″ Box Tubing Frame
Adjustable Feet
Stainless Steel Tubing
3.0″ Modulating Valve
I/P Transducer
3.0″ Vortex meter
480V 15 hp Variable Frequency Drive
RTD w/Wiring Head and Transmitter
NEMA 4× Control Enclosure
24-Volt Power Supply
Start/Stop Push Buttons
Main Power Disconnect
4-20 mA Controller w/I-P for Balance Tank Level

Item 2: Hold Tube
2.0″ Box Tubing Frame
3.0″ Stainless Tubing for Product
3.0″ sch 5 Tubing for Hot Water Jacket
Vibration Isolation Feet

Item 3: Clean Product Feed System
10 hp Wash-down Motor
2.0″ Box Tubing Frame
Adjustable Feet
Stainless Steel Tubing
Legal Collection Balance Tank
Centrifugal Pump to Deliver Clean Tallow to Dryer
High Temperature Pressure Transmitter
480V 10 hp Variable Frequency Drive
NEMA 4× Control Enclosure
E-stop Push Buttons
Start/Stop Push Buttons
Main Power Disconnect
   Tallow Dryer

A tallow dryer may be provided to remove excess water from liquid tallow using a vacuum tank. The monitoring system monitors the level of tallow in the balance tank and tallow dryer and adjusts the flow rate to maintain appropriate levels. Once the tallow is dried, it may be cooled using a plate and frame heat exchanger.

A main control cabinet and air enclosure may be located on the tallow dryer skid. The main enclosure controls product temperatures, flow rates, valve actuation, pump speeds, and tank levels.

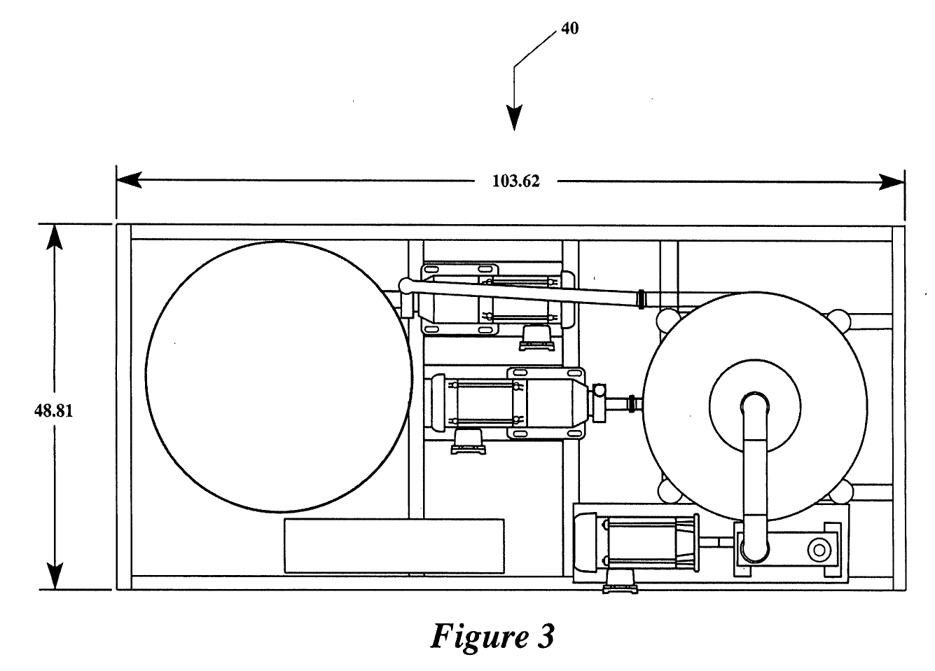

FIG. 3 illustrates a dryer 40 in accordance with one embodiment. Specifications for a suitable tallow dryer for a system for insoluble reduction in tallow are provided. The specifications are exemplary only and are not intended to be limiting.
2.0″ Box Tubing Frame
Adjustable Feet
Stainless Steel Tubing
Sight Glass on Vacuum Tank
Fristram Vacuum Tank Supply Pump
Fristram Vacuum Tank Discharge Pump
Sihi Vacuum Pump
Divert Valve for CIP
Vacuum Tank Modulating Supply Control Valve
Tallow Condensor
NEMA 4× Control Enclosure
E-stop Push Buttons
Start/Stop Push Buttons
24-Volt Power Supply
Air Solenoid Valves
480V Variable Frequency Drives for Supply and Discharge Pumps
Starter Contractor and Heater for Vacuum Pump
4-20 mA Controller w/I-P for Balance Tank Level
4-20 mA Controller for Vacuum Tank Level
Main Power Disconnect
Balance Level Transmitter
   System

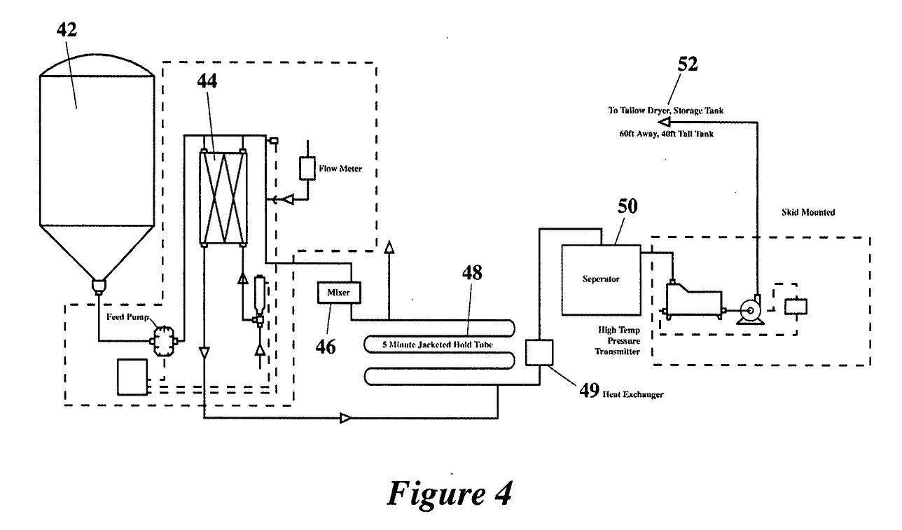

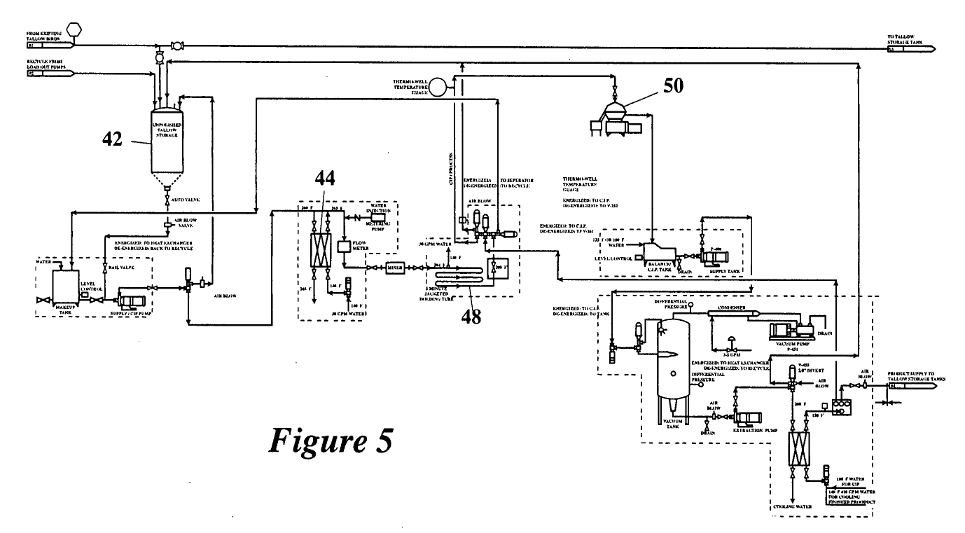

Thus, as shown in FIGS. 4 and 5, the tallow is stored in a product supply tank 42. The tallow is pumped to a first heat exchanger 44 for heating or cooling the tallow to a predetermined temperature. The tallow is then pumped to a mixer 46 where it is mixed with water. The tallow-water mixture is pumped through a holding tube assembly 48 for a predetermined retention time. After the predetermined retention time, the tallow-water mixture is run through a second heat exchanger 49 and a separator 50 where cleaned tallow is separated from solids. The cleaned tallow is then pumped to a tallow dryer and storage 52. The cleaned tallow may be cooled after drying using a third heat exchanger.

Although the invention has been described with reference to preferred embodiments, persons skilled in the art will recognize that changes may be made in form and detail without departing from the spirit and scope of the invention.

1. A method for reducing insolubles in tallow comprising:
providing tallow in a tallow tank;
mixing the tallow with water to form a tallow and water mixture; and
separating insolubles from the tallow and water mixture to produce cleaned tallow.

2. The method of claim 1, further comprising bringing the tallow to a first predetermined temperature prior to mixing the tallow with water.

3. The method of claim 2, wherein the first predetermined temperature is approximately 205° F.

4. The method of claim 2, further comprising bringing the tallow and water mixture to a second predetermined temperature prior to separating insolubles from the tallow and water mixture.

5. The method of claim 4, wherein the second predetermined temperature is approximately 205° F.

6. The method of claim 1, further comprising holding the tallow and water mixture for a retention time prior to separating insolubles from the tallow and water mixture.

7. The method of claim 6, w herein t he holding comprises pumping the tallow and water mixture through a holding tube assembly.

8. The method of claim 6, wherein the retention time is approximately 5 minutes.

9. The method of claim 1, further comprising drying the cleaned tallow.

10. The method of claim 9, further comprising cooling the cleaned tallow after drying the cleaned tallow.

11. The method of claim 1, further comprising removing solids after separating the insolubles from the tallow and water mixture and feeding the solids to a rendering process.

12. A method for reducing insolubles in tallow comprising:
placing tallow in a tallow tank;
bringing the tallow to a first predetermined temperature;
mixing the tallow with water to form a tallow and water mixture;
bringing the tallow and water mixture to a second predetermined temperature;
holding the tallow and water mixture for a predetermined retention time by pumping the tallow and water mixture through a holding tube assembly;
separating insolubles from tallow to produce cleaned tallow; and
drying the cleaned tallow.

12. A system for reducing insolubles in tallow comprising:
a feed tank for holding tallow;
a mixer configured for mixing tallow from the feed tank and water; and
a separator configured for separating solids from the tallow.

13. The system of claim 12, wherein the separator is a two-phase vertical centrifuge.

14. The system of claim 13, wherein the separator further comprises a mixing pump and jacketed piping to ensure contact time for a continuous flow.

15. A system for reducing insolubles in tallow comprising:
a feed tank for holding the tallow;
a first heat exchanger for bringing the tallow to a predetermined temperature;
a mixer for mixing the tallow with water to form a tallow and water mixture;
a holding tube assembly for holding the tallow and water mixture for a retention time;
a second heat exchanger for bringing the tallow and water mixture to a predetermined temperature;
a separator for separating insolubles from the tallow and water mixture to produce cleaned tallow; and
a tallow dryer for drying the cleaned tallow;
wherein the tallow tank, the first heat exchanger, the mixer, the holding tube assembly, the second heat exchanger, the separator, and the tallow dryer are operably coupled in series.
